(19) United States
(12) Patent Application Publication
(10) Pub. No.: US 2017/0265263 A1
(43) Pub. Date: Sep. 14, 2017

(54) LIGHTING APPARATUS WITH A VARIABLE LIGHT BEAM EMISSION ANGLE

(71) Applicant: ARTEMIDE S.p.A., Milano (IT)

(72) Inventors: Fabio Zanola, Missaglia (IT); Luca Porcaro, Milano (IT); Roberto Efrem Franzosi, Milano (IT)

(21) Appl. No.: 15/455,402

(22) Filed: Mar. 10, 2017

(30) Foreign Application Priority Data
Mar. 11, 2016 (IT) 102016000026002

(51) Int. Cl. H05B 33/08; F21V 23/00; F21V 23/04; F21V 29/77; F21V 3/00

(52) U.S. Cl. CPC H05B 33/0845; F21V 29/77; F21V 3/00; F21V 23/04; F21V 23/008

(57) ABSTRACT

A lighting apparatus with a variable light beam emission angle comprises a base body extending along an axis and a plurality of optical groups mounted on the base body; each optical group comprises a light source and a dedicated optical system associated with the light source; the optical groups are provided with optical systems configured so as to generate respective light beams having at least two different emission angles; a control system acts on the light sources to selectively turn on/turn off the light sources.

### PRIORITY CLAIM

This application claims priority from Italian Patent Application No. 102016000026002 filed on Mar. 11, 2016, the disclosure of which is incorporated by reference.

### TECHNICAL FIELD

The present invention relates to a lighting apparatus, in particular a LED lighting apparatus, capable of emitting light beams having different amplitudes (emission angles).

### BACKGROUND OF THE INVENTION

Varying the amplitude of the light beam emitted by a lighting apparatus by means of adjustment mechanisms acting on optical elements, typically lenses, and operated manually or by means of a motorized actuator, is well known.

These types of solutions are relatively complex to construct and assemble, since they usually require the use of multiple mechanical parts in relative motion; for the same reason, these systems may not be fully reliable, being subject to possible malfunction or breakage problems.

### SUMMARY OF THE INVENTION

It is an object of the present invention to provide a lighting apparatus, in particular a LED lighting apparatus, with a variable light beam emission angle (i.e. capable of emitting light beams having different amplitudes or emission angles), which allows overcoming the drawbacks of the prior art described herein.

In particular, it is an object of the invention to provide a lighting apparatus which allows the amplitude of the emitted light beam to be adjusted in a simple and accurate manner, without requiring the use of moving mechanical parts, and therefore proving to be particularly simple to manufacture besides being fully reliable.

The present invention therefore relates to a lighting apparatus as defined in appended claim 1.

Further preferred features of the invention are defined in the dependent claims.

Compared to lighting apparatuses with an adjustable light beam manufactured according to the prior art, the invention provides a completely different approach: instead of using movable optical elements to vary the emission angle of the light emitted by a light source, according to the invention a plurality of light sources are used, each one being associated with a dedicated optical system capable of emitting a beam having a predetermined opening. By selectively switching on one or more light sources it is thus possible to provide a light beam having a different amplitude, without requiring mechanical adjustments.

The solution of the invention is simple and functional and fully reliable.

### BRIEF DESCRIPTION OF THE DRAWINGS

Further features and advantages of the present invention will be apparent from the following description of a preferred non-limiting embodiment thereof, with reference to the figures of the accompanying drawings, wherein:

FIG. 1 is a front view of a lighting apparatus according to the invention;

FIG. 2 is a side view, with a part in longitudinal section, of the lighting apparatus of FIG. 1.

### DETAILED DESCRIPTION OF THE INVENTION

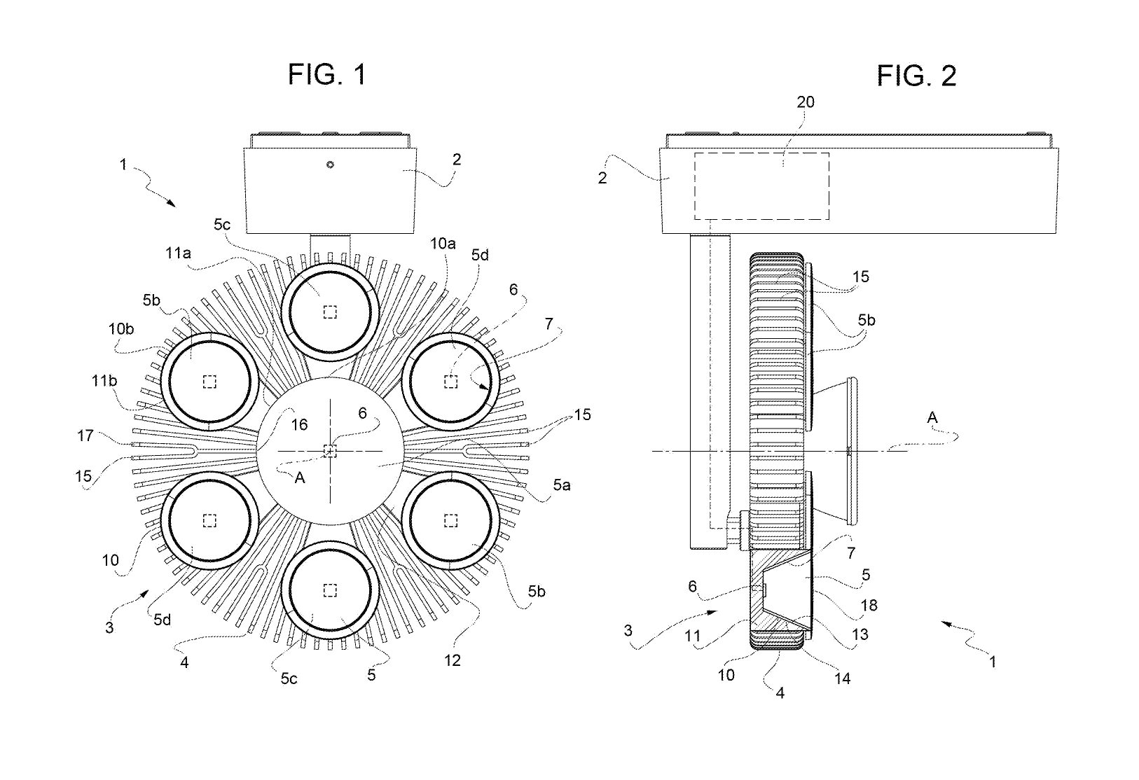

In FIGS. 1 and 2, the numeral 1 indicates, as a whole, a lighting apparatus with a variable light beam emission angle capable of emitting light beams having different amplitudes (emission angles).

The apparatus 1 comprises a support structure 2 and a lighting head 3 supported by the support structure 2.

The support structure 2 may take various shapes, also depending on the intended purpose of the apparatus 1 (which may serve as a swinging lamp, a wall lamp, a recessed lamp, etc.). Optionally, the support structure 2 includes articulations and/or joints in order to allow the position or orientation of the lighting head 3 to be varied.

The lighting head 3 comprises a base body 4 and a plurality of optical groups 5 mounted on the base body 4: each optical group 5 comprises a light source 6 and a dedicated optical system 7 acting exclusively on the light emitted by that same light source 6.

The base body 4 extends along a longitudinal axis A.

In the illustrated example, the base body 4 is disc-shaped about axis A, but it is understood that the base body 4 can have different shapes.

Advantageously, the base body 4 also serves as a thermal dissipator for the light sources 6. The base body 4 is thus (at least partly) made of a heat conductive material such as a metallic material, for example aluminium, in particular extruded or die-cast aluminium.

The base body 4 comprises a plurality of housings 10 formed in respective portions 11 of the base body 4 for housing respective optical groups 5.

In particular, the base body 4 comprises a central housing 10a, formed in a central portion 11a positioned along the axis A of the base body 4; and a plurality of peripheral housings 10b, formed in respective radially eccentric portions 11b of the base body 4 positioned about axis A and the central portion 11a, and connected to the central portion 11a, for example, by radial ribs 12.

The portions 11 are hollow portions, which are substantially cup-shaped and provided with respective internal seats 13 extending along respective axes parallel to axis A; each seat 13 is delimited by a lateral wall 14 and is open at the front.

The central portion 11a extends along axis A, the eccentric portions 11b are located about axis A and are angularly spaced apart, for example equally spaced apart, from one another.

The base body 4 further comprises a plurality of heat exchange fins 15 connected to the portions 11.

In particular, the base body 4 comprises a plurality of fins 15 which depart from the central portion 11a, to which they are connected by means of respective root ends 16; the fins 15 are arranged in a radial pattern about axis A and extend radially from the central portion 11a and precisely from its lateral wall 14.

The fins 15 are angularly spaced apart and separated from one another and have respective free ends 17, opposite to the root ends 16, and separated from one another.

Optionally, as in the example illustrated in FIGS. 1-2, some fins 15 (or even all the fins 15) fork towards the respective free ends 17 and have a fork shape with two or more prongs.

Some fins 15 can also connect the portions 11, in particular the central portion 11a, to each of the other (eccentric) portions 11b, or depart from the eccentric portions 11b.

The fins 15 have heights, as measured parallel to axis A and defining the axial thickness of the base body 4, which are preferably even (all the fins 15 have the same height).

Advantageously, but not necessarily, the housings 10 are formed at least in part inside the thickness of the base body 4, i.e. the housings 10 extend at least in part between the fins 15.

Each housing 10 houses an optical group 5, which comprises a light source 6 and a dedicated optical system 7.

In particular, the light sources 6 are LED light sources, each of which comprises one or more LEDs.

In accordance with the invention, the apparatus 1 comprises different optical groups 5: in particular, at least some of the optical groups 5 are provided with optical systems 7 configured so as to generate light beams having respective different openings: the apparatus 1 thus includes optical systems 7 that emit beams with at least two different emission angles (opening angles of the emitted beam).

Two or more optical groups 5, preferably evenly distributed about axis A, can also emit beams having the same emission angle.

For example, the apparatus 1 includes two or more pairs of optical groups 5 which emit beams with the same emission angle; the optical groups 5 of each pair (which emit beams having the same emission angle) are positioned diametrically opposite with respect to axis A.

The light sources 6 of the various optical groups 5 may be the same or different from each other: in particular, it is possible to use the same light sources 6 in all of the optical groups 5, or the same light sources 6 in optical groups 5 having the same emission angle and different light sources 6 for optical groups 5 having different emission angles.

The optical systems 7 can be of various kinds: in general, each optical system 7 is located in front of and/or around the respective associated light source 6 and is shaped so as to convey the light emitted by the respective light source 6 into a beam coming out from the optical group with a fixed and predetermined amplitude (opening).

For example, the optical systems 7 comprise or consist of reflectors, refractive optical elements, or other elements.

Preferably, the optical systems 7 are also provided with respective front transparent protection covers 18.

Preferably, the apparatus 1 comprises a first optical group 5a, placed at the centre of the apparatus 1 along axis A in the central housing 10a, and a series of other optical groups 5b, 5c, 5d located in the peripheral housings 10b and thus arranged in a radial pattern about axis A, and angularly and regularly spaced apart from one another.

In the purely illustrative embodiment shown in the figures, the apparatus 1 comprises seven optical groups 5 equipped with optical systems 7 capable of emitting beams having four different amplitudes:
a first optical group 5a, which is positioned along axis A (in the central housing 10a) and emits a beam having a first emission angle (for example, a highly collimated beam, the so-called “SUPER SPOT” beam);
a pair of second optical groups 5b positioned diametrically opposite with respect to axis A in respective peripheral housings 10b, each of which emits a beam having a second emission angle which is larger than the first emission angle (for example, a medium collimation beam, the so-called “SPOT” beam);
a pair of third optical groups 5c positioned diametrically opposite with respect to axis A in respective peripheral housings 10b, each of which emits a beam having a third emission angle which is larger than the second emission angle (for example, a so-called “MEDIUM” beam);
a pair of fourth optical groups 5d positioned diametrically opposite with respect to axis A in respective peripheral housings 10b, each of which emits a beam having a fourth emission angle which is larger than the third emission angle (for example, a so-called “WIDE” beam);

The amplitude of the beams emitted by the various optical groups 5 and therefore the shape of the various optical systems 7 can clearly be established depending on specific requirements.

However, it is to be understood that various combinations of optical systems 7 may be provided.

The apparatus 1 further comprises a control system 20 acting on the light sources 6 to selectively turn on/turn off the light sources 6.

For example, the control system 20 is housed in the support structure 2 and is connected to the light sources 6 via cables (only schematically shown in FIG. 2).

In particular, the control system 20 is a multichannel control system, which permits to operate independently a plurality of light sources 6 or groups of light sources 6 so as to emit beams having different openings (i.e. having different emission angles) and also to combine beams having different openings.

By turning on only the light source 6 of the first optical group 5a, a beam having the first emission angle (“SUPER SPOT”) is obtained.

By turning on only the light sources 6 of one of the other optical group pairs 5b, 5c, 5d, a beam having the corresponding emission angle, which is increasingly larger (“SPOT”, “MEDIUM”, “WIDE”) is obtained.

It is also possible to turn on various combinations of light sources 6 to vary still further the emission of the apparatus 1.

The control system 20 optionally also controls the light intensity of the light sources 6, so as to adjust the emission luminosity of the apparatus 1, as well as the emission angle.

Lastly, it is understood that the lighting apparatus as described and illustrated herein can be subject to modifications and variations that do not depart from the scope of the accompanying claims.

1. A lighting apparatus (1) with a variable light beam emission angle, comprising a base body (4) extending along an axis (A) and a plurality of optical groups (5) mounted on the base body (4); each optical group (5) comprising a light source (6) and a dedicated optical system (7) associated with said light source (6); the apparatus (1) being characterized by comprising optical groups (5) provided with optical systems (7) configured so as to generate respective light beams having at least two different emission angles; and a control system (20) acting on the light sources (6) to selectively turn on/turn off the light sources (6).

2. An apparatus according to claim 1, wherein the control system (20) is a multichannel control system which permits to operate independently a plurality of light sources (6) and/or groups of light sources (6).

3. An apparatus according to claim 1, wherein the control system (20) also controls the light intensity of the light sources (6), so as to adjust not only the emission angle, but also the luminosity of the apparatus (1).

4. An apparatus according to claim 1, wherein two or more optical groups (5) emit beams having the same emission angle.

5. An apparatus according to claim 1, wherein optical groups (5) that emit beams having the same emission angle are evenly distributed about the axis (A).

6. An apparatus according to claim 1, and comprising two or more pairs of optical groups (5) that emit beams having the same emission angle; the optical groups (5) of each pair being positioned diametrically opposite with respect to the axis (A).

7. An apparatus according to claim 1, and comprising optical groups (5) provided with optical systems (7) configured for emitting respective beams having three or more different emission angles.

8. An apparatus according to claim 1, and comprising a first optical group (5a), centrally positioned along the axis (A), and a series of other optical groups (5b, 5c, 5d) arranged in a radial pattern about the axis (A) and angularly spaced apart from one another.

9. An apparatus according to claim 1, and comprising a first optical group (5a) that emits a beam having a first emission angle; and one or more sets of other optical groups (5b) that emit respective beams having respective further emission angles, larger than the first emission angle.

10. An apparatus according to claim 9, wherein a pair of second optical groups (5b), positioned diametrically opposite with respect to the axis (A), emit respective beams having a second emission angle, larger than the first emission angle.

11. An apparatus according to claim 10, wherein a pair of third optical groups (5c), positioned diametrically opposite with respect to the axis (A), emit respective beams having a third emission angle, larger than the second emission angle.

12. An apparatus according to claim 11, wherein a pair of fourth optical groups (5d), positioned diametrically opposite with respect to the axis (A), emit respective beams having a fourth emission angle, larger than the third emission angle.

13. An apparatus according to claim 1, wherein the base body (4) comprises a plurality of housings (10) formed in respective portions (11) of the base body (4) for housing respective optical groups (5).

14. An apparatus according to claim 13, wherein the base body (4) comprises a central housing (10a), formed in a central portion (11a), positioned along the axis (A), of the base body (4); and a plurality of peripheral housings (10b), formed in respective radially eccentric portions (11b) of the base body (4); said radially eccentric portions (11b) being positioned about the axis (A) and the central portion (11a) and being connected to the central portion (11a), for example, by radial ribs (12).

15. An apparatus according to claim 13, wherein the base body (4) also acts as a thermal dissipator and comprises a plurality of heat exchange fins (15) which depart radially from a central portion (11a) of the base body (4) and extend substantially parallel to the axis (A) and are angularly spaced apart and separated from one another.

16. An apparatus according to claim 15, wherein the fins (15) are connected to the central portion (11a) of the base body (4) by respective root ends (16) and have respective free ends (17), opposite to the root ends (16), separated from one another.

17. An apparatus according to claim 16, wherein at least some fins (15) fork towards the respective free ends (17) and have a fork shape with two or more prongs.

18. An apparatus according to claim 15, wherein at least some housings (10) extend at least in part between the fins (15), being formed at least in part inside the thickness of the base body (4), the thickness of the base body (4) being defined by the height, as measured parallel to the axis (A), of the fins (15).
